(19) United States
(12) Patent Application Publication
(10) Pub. No.: US 2026/0362074 A1
(43) Pub. Date: Nov. 12, 2026

(54) METHOD AND APPARATUS FOR EFFICIENT AUDIO RENDERING

(71) Applicant: DOLBY INTERNATIONAL AB, Dublin (IE)

(72) Inventors: Daniel FISCHER, Fuerth (DE); Leon TERENTIV, Erlangen (DE); Panji SETIAWAN, Munich (DE); Christof Joseph FERSCH, Neumarkt (DE)

(73) Assignee: DOLBY INTERNATIONAL AB, Dublin (IE)

(21) Appl. No.: 19/137,105

(22) PCT Filed: Dec. 12, 2023
(86) PCT No.: PCT/EP2023/085408

§ 371 Date: Jun. 9, 2025

Related U.S. Application Data
(60) Provisional application No. 63/431,822, filed on Dec. 12, 2022.
(60) Provisional application No. 63/491,258, filed on Mar. 20, 2023.

(51) Int. Cl. H04S 7/00; H04S 3/00

(52) U.S. Cl. CPC H04S 7/302; H04S 3/008; H04S 2400/01; H04S 2400/11; H04S 2400/13

(57) ABSTRACT

Described herein is a method of rendering audio sources, the method comprising: determining, for each of a plurality of audio sources, a rendering control value based on one or more parameters indicative of a perceptual relevance of the respective audio source; comparing, for each of the plurality of audio sources, the rendering control value to a perceptibility threshold to determine whether a respective audio source fulfills a perceptual irrelevance criterion; modifying audio sources, out of the plurality of audio sources, for which the rendering control value satisfies the threshold to obtain modified audio sources; and rendering unmodified audio sources, out of the plurality of audio sources, relative to the modified audio sources. Described are further methods for processing audio, respective apparatus and computer program products.

This application claims the benefit of priority from U.S. Provisional Application Ser. No. 63/431,822 filed on 12 Dec. 2022, and U.S. Provisional Application Ser. No. 63/491,258 filed on 20 Mar. 2023, each of which is incorporated by reference herein in its entirety.

### TECHNICAL FIELD

The present disclosure relates generally to a method of rendering audio sources. In particular, the present disclosure relates to controlling the rendering of audio sources for efficient audio rendering.

While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

Audio rendering, in particular of high quality immersive content, is computationally expensive. To render immersive audio, especially on power limited devices, within reasonable operation times, allows only very complexity constrained numerical operations on the processors included in them. Thus, the output audio is often degraded in quality and the listener experience is poor.

There is thus an existing need for method and apparatus that allow efficient rendering of audio sources without perceptual quality degradation of the resulting rendered audio output.

### SUMMARY

In accordance with a first aspect of the present disclosure there is provided a method of rendering audio sources. The method may comprise determining, for each of a plurality of audio sources, a rendering control value based on one or more parameters indicative of a perceptual relevance of the respective audio source. The method may further comprise comparing, for each of the plurality of audio sources, the rendering control value to a perceptibility threshold to determine whether a respective audio source fulfills a perceptual irrelevance criterion. The method may further comprise modifying audio sources, out of the plurality of audio sources, for which the rendering control value satisfies the threshold to obtain modified audio sources. And the method may comprise rendering unmodified audio sources, out of the plurality of audio sources, relative to the modified audio sources.

In some embodiments, the one or more parameters may include a loudness of a respective audio source. The rendering control value may then be determined based on a loudness value.

In some embodiments, the one or more parameters may include a relationship between the loudness of a single audio source and the loudness of audio output resulting from rendering the plurality of audio sources excluding said single audio source.

In some embodiments, the one or more parameters may include a relationship between a short-term spectral energy of a single audio source and a spectral energy of audio output resulting from rendering the plurality of audio sources.

In some embodiments, the rendered audio output may be associated with a psychoacoustic-masking model.

In some embodiments, the modifying the audio sources for which the rendering control value satisfies the threshold may include culling the audio sources. The modified audio sources may then correspond to a culling sub-set of the plurality of audio sources.

In some embodiments, the rendering the unmodified audio sources, out of the plurality of audio sources, relative to the modified audio sources may include not to render the audio sources included in the culling sub-set.

In some embodiments, the one or more parameters may include a positional proximity of an audio source in respect to a listener position.

In some embodiments, the rendering control value may be determined based on a distance of a respective audio source position of the audio source for which the rendering control value is determined to another audio source, and wherein the rendering control value may be compared with a fraction of a distance between the listener position and a closest source position.

In some embodiments, the one or more parameters may include a directional proximity with respect to a listener position.

In some embodiments, the rendering control value may be determined based on at least one of azimuth or elevation between the respective audio source position of the audio source for which the rendering control value is determined and the listener position.

In some embodiments, the modifying the audio sources may include clustering the audio sources for which the rendering control value satisfies the threshold. The modified audio sources may then correspond to cluster audio sources.

In some embodiments, the rendering the unmodified audio sources, out of the plurality of audio sources, relative to the modified audio sources may include substituting the cluster audio sources by a smaller number of audio sources and rendering the smaller number of audio sources as the modified audio sources.

In some embodiments, the one or more parameters may include one or more of acoustic occlusion, optical occlusion, or abstraction. The rendering control value may then be determined based on a level of occlusion or abstraction of the respective audio source.

In some embodiments, the modifying the audio sources may include converting a type of the audio sources for which the rendering control value satisfies the threshold. The modified audio sources may then correspond to typecasted audio sources.

In some embodiments, the rendering the unmodified audio sources, out of the plurality of audio sources, relative to the modified audio sources may include rendering the typecasted audio sources as the modified audio sources.

In some embodiments, on audio sources, out of the plurality of audio sources, which have a directivity pattern, a directivity calculation may not be performed, if the rendering control value satisfies the threshold.

In some embodiments, the method may further include receiving control information indicative of whether to perform the modifying of some or all of the audio sources for which the rendering control value satisfies the threshold.

In some embodiments, the control information may be one of activation or deactivation parameters, grouping data, prioritization information, and/or visibility information.

In accordance with a second aspect of the present disclosure there is provided an apparatus for rendering audio sources. The apparatus may include one or more processors configured to implement a method including: determining, for each of a plurality of audio sources, a rendering control value based on one or more parameters indicative of a perceptual relevance of the respective audio source; comparing, for each of the plurality of audio sources, the rendering control value to a perceptibility threshold to determine whether a respective audio source fulfills a perceptual irrelevance criterion; modifying audio sources, out of the plurality of audio sources, for which the rendering control value satisfies the threshold to obtain modified audio sources; and rendering unmodified audio sources, out of the plurality of audio sources, relative to the modified audio sources.

In accordance with a third aspect of the present disclosure there is provided an apparatus comprising a processor and a memory coupled to the processor, and storing instructions for the processor, wherein the processor is adapted to carry out the method described herein.

In accordance with a fourth aspect of the present disclosure there is provided a program comprising instructions that, when executed by a processor, cause the processor to carry out the method described herein. A computer-readable storage medium may store the program.

It will be appreciated that apparatus (system) features and method steps may be interchanged in many ways. In particular, the details of the disclosed method(s) can be realized by the corresponding apparatus (system), and vice versa, as the skilled person will appreciate.

Moreover, any of the above statements made with respect to the method(s) are understood to likewise apply to the corresponding apparatus (system), and vice versa.

### BRIEF DESCRIPTION OF THE DRAWINGS

Example embodiments of the disclosure will now be described, by way of example only, with reference to the accompanying drawings in which:

FIG. 1 illustrates an example of a method of rendering audio sources according to an embodiment of the disclosure.

FIG. 2 illustrates schematically an example of culling audio sources according to an embodiment of the disclosure.

FIG. 3 illustrates schematically an example of clustering audio sources according to an embodiment of the disclosure.

FIG. 4 illustrates schematically another example of clustering audio sources according to an embodiment of the disclosure.

FIG. 5 illustrates schematically an example of typecasting audio sources according to an embodiment of the disclosure.

FIG. 6 illustrates an example of a method of processing audio according to an embodiment of the disclosure.

FIG. 7 illustrates another example of a method of processing audio according to an embodiment of the disclosure.

FIG. 8 illustrates yet another example of a method of processing audio according to an embodiment of the disclosure.

FIG. 9 illustrates an example of using control information according to an embodiment of the disclosure.

FIG. 10 illustrates schematically an example of control information parameters according to an embodiment of the disclosure.

FIG. 11 illustrates an example of an apparatus comprising a processor and a memory coupled to the processor according to an embodiment of the disclosure.

It is noted that wherever practicable similar or like reference numbers may be used in the figures and may indicate similar or like functionality. The figures depict embodiments of the disclosed apparatus (or method) for purposes of illustration only. One skilled in the art will readily recognize from the following description that alternative embodiments of the structures and methods illustrated herein may be employed without departing from the principles described herein.

Furthermore, in the figures, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the present disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

### DESCRIPTION OF EXAMPLE EMBODIMENTS

### Overview

Methods and apparatus as described herein provide the technical benefits and advantages of decreasing computational and memory system workload without perceptual quality degradation of the resulting rendered audio output. An absence of perceptual quality degradation may be understood as providing a similar (or better) listener subjective experience. For example, the present disclosure provides for a method that modifies audio output to achieve this benefit, as opposed to un-modified audio output. Moreover, the present disclosure provides the additional benefit of workload reduction. This reduction may be achieved by modifying and/or deactivating of selected audio source digital signal processing, DSP, instances and optionally associated metadata processing.

Parameters, downmix matrices and/or related information for methods described herein can be defined and signaled by an encoder, decoder/renderer, and/or application. For example, an encoder can operate in an “encoder-assisted” mode where the encoder can manually allow a content-creator to have an influence on an otherwise automatic method. This can provide the benefit of avoiding non-sensical culling as described below. Alternatively, this information can be provided in a decoder and/or renderer (e.g., automatically being provided in a “default” mode). Alternatively, the information can be provided by an application (e.g., in a “system-assisted” mode being provided automatically by application or system middleware).

### Methods of Rendering Audio Sources

The present disclosure is directed towards reducing a number of rendered audio sources for removing complexity at the renderer without psychoacoustic impact. Such audio sources may be any type of audio input sources, such as, for example, channel (static) sources, audio object(s), Higher Order Ambisonic(s), HOA, First Order Ambisonics, FOA, and/or B-format ambisonics.

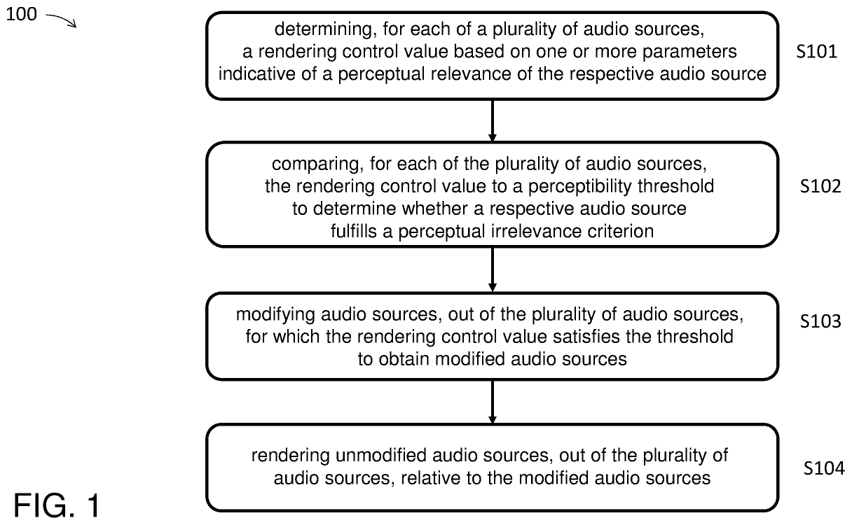

Referring to the example of FIG. 1, a method of rendering audio 100 is illustrated.

In step S101 of the method, for each of a plurality of audio sources, a rendering control value is determined based on one or more parameters indicative of a perceptual relevance of the respective audio source.

In step S102 of the method, for each of the plurality of audio sources, the rendering control value is compared to a perceptibility threshold to determine whether a respective audio source fulfills a perceptual irrelevance criterion.

In step S103, audio sources, out of the plurality of audio sources, for which the rendering control value satisfies the threshold are modified to obtain modified audio sources.

And in step S104, unmodified audio sources, out of the plurality of audio sources, are rendered relative to the modified audio sources.

In an embodiment, the one or more parameters (for determining the rendering control value) may include a loudness of a respective (single) audio source. The rendering control value may then be determined based on a respective loudness value. Depending on the use case, loudness values may be obtained from:
1) Metadata from existing audio standards set by the MPEG audio group, including the MPEG-H 3D audio (ISO_IEC_23008-3) or MPEG-D part 4 (Dynamic Range Control). For example the metadata may be presented for a legacy content;
2) Information for encoders set by the MPEG audio group, such as encoders compatible with MPEG-H 3D audio or MPEG-I audio standards. For example, the loudness information may be estimated and transmitted via an MPEG-H Audio Stream (MHAS) packet payload;
3) Information by an MPEG-I renderer. For example, information estimated in real time using the audio content and rendering gains.

The above described loudness data sources may be applied alone or in combination; the latter, for example, for content without or with non-reliable loudness information, social virtual reality, VR, content, etc.

In general, the loudness may be signaled and treated differently depending on different loudness definitions and measurement methods, for example, short term, momentary, level gated, IBU defined etc.

Alternatively, or additionally, in an embodiment, the one or more parameters may include a relationship between the loudness of a single audio source and the loudness of audio output resulting from rendering the plurality of audio sources excluding said single audio source. Such a relationship may be, for example, in a non-limiting manner a signal to noise ratio. Other measures may also be conceivable as well using, for example, spatial masking.

Alternatively, or additionally, in an embodiment, the one or more parameters may include a relationship between a short-term spectral energy of a single audio source and a spectral energy of audio output resulting from rendering the plurality of audio sources. The rendererd audio output may be associated with a psychoacoustic-masking model.

The above described parameters may be used alone or in combination to determine the respective rendering control value for each of the plurality of audio sources. The rendering control value may then be said to be indicative of a perceptual relevance (perceptibility) of the respective audio source. Comparing, for each of the plurality of audio sources, the rendering control value to a (predetermined) perceptibility threshold may then indicate as to whether the respective audio source is perceptually relevant or irrelevant, that is, as to whether the respective audio source fulfills a perceptual irrelevance criterion. For example, if the rendering control value is equal to or above a certain threshold value, the respective audio source may be considered to be perceptually relevant. If the rendering control value is below a certain threshold value, the respective audio source may be considered to be perceptually irrelevant, that is, the respective audio source fulfills/satisfies the perceptual irrelevance criterion.

For example, an audio source associated to a bird singing audio may become perceptually irrelevant if a listener would start to experience heavy rain noise. In this case, the rendering control value would satisfy the respective (perceptual relevance) threshold, the respective audio source would fulfill the perceptual irrelevance criterion.

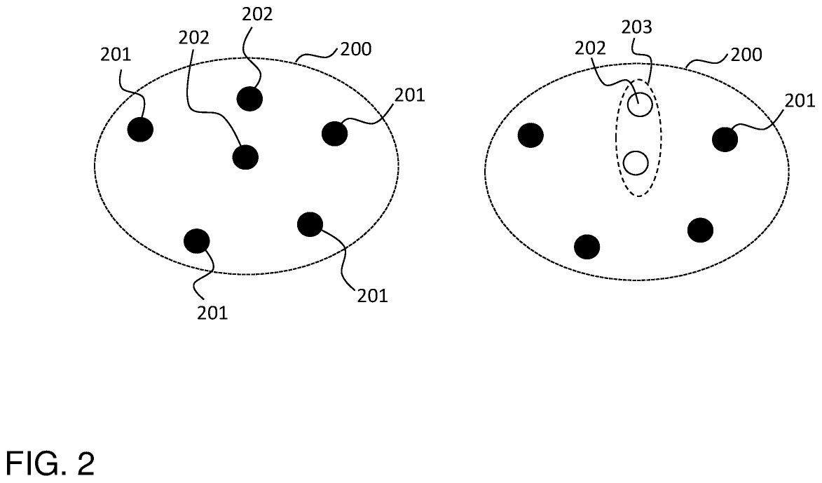

In an embodiment, the modifying of the audio sources for which the rendering control value satisfies the threshold may include culling the audio sources. The modified audio sources may then correspond to a culling sub-set of the plurality of audio sources. Referring to the example of FIG. 2, the culling of audio sources is illustrated schematically by forming a respective culling sub-set. FIG. 2 illustrates a plurality of audio sources 201, 202 associated to a respective audio scene 200. Referring again to the example above, the audio sources 202 may be associated to a bird singing, the audio sources 201 may be associated with a light rain. If a listener now starts to experience heavy rain noise 201, the audio sources associated with the bird singing 202 may become perceptually irrelevant, i.e. the rendering control value may satisfy the perceptibility threshold. In this case, the audio sources 202 are modified in that the audio sources may be culled. The culled audio sources may then correspond to a respective culling sub-set 203.

Culling, in this context, may be said to refer to removing the respective perceptually irrelevant audio sources. That is, in an embodiment, the rendering the unmodified audio sources, out of the plurality of audio sources, (for which the rendering control value may not satisfy the perceptibility threshold) relative to the modified audio sources may include not to render the audio sources included in the culling sub-set.

In considering additional perceptual energy/loudness-related aspects for the estimation of perceptual relevance and setting the respective rendering control condition based on comparing the respective rendering control value to the perceptibility (perceptual relevance) threshold to determine whether a respective audio source fulfills a perceptual irrelevance criterion, improvements over conventional methods for detecting irrelevance of audio sources are achieved in that conventional methods merely consider a distance (from a listener to an audio object) and/or rendering gains (of an audio object). In other words, conventional methods may be said to apply blind culling in that actual signals and signal energies are not considered. The conventional approach is thus not capable to detect subclasses of perceptually irrelevant audio sources. Namely, the sources which are not audible, but have the corresponding distance and gain values above the conventional culling threshold. Consequently, in the conventional approach, audio sources that should remain may be removed and vice versa.

In an embodiment, the one or more parameters (for determining the rendering control value) may alternatively, or additionally, include a positional proximity (close source location) of an audio source in respect to a listener position. The rendering control value may then be determined based on a distance of a respective audio source position of the audio source for which the rendering control value is determined to another audio source, and the rendering control value may be compared with a fraction of a distance between the listener position and a closest source position. For example, a distance between N audio source locations may be smaller than T_{distance}% of the distance between the listener and the closest source. T_{distance}% refers to a variable denoting a percentage value, (e.g., 5%). As a listener explores a scene containing several audio sources (i.e., the original N audio sources), the distance between the listener to a closest source can be calculated. This distance to this closest source can be referred to as a variable Tc. Additionally, the distance between each of the remaining audio sources in that scene can also be calculated. Each of these distances is compared against Tc. If a distance between two sources is less than T_{distance}% of Tc, then these sources are clustered (grouped together). The cluster may add to or remove from it more members (audio sources) since the comparison is done on all audio sources.

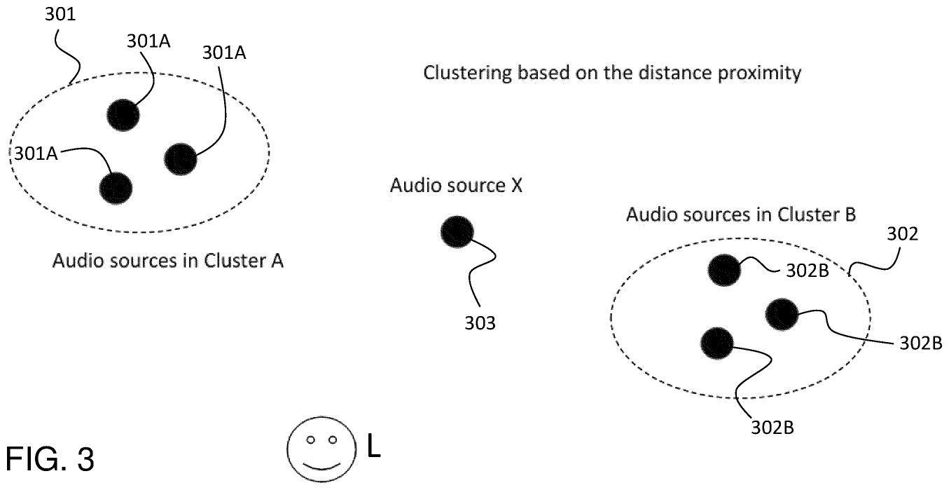

FIG. 3 illustrates an example of abstract visualization of clustering based on positional proximity. As can be seen in FIG. 3, cluster A 301 contains the audio sources 301A closest to one another in terms of distance. Cluster B 302 contains different sources 302B that, likewise, are closest to one another in terms of distance. Conversely, source X 303 is located further away from any audio source 301A, 302B in both clusters A 301 and B 302, and hence is not assigned to either cluster.

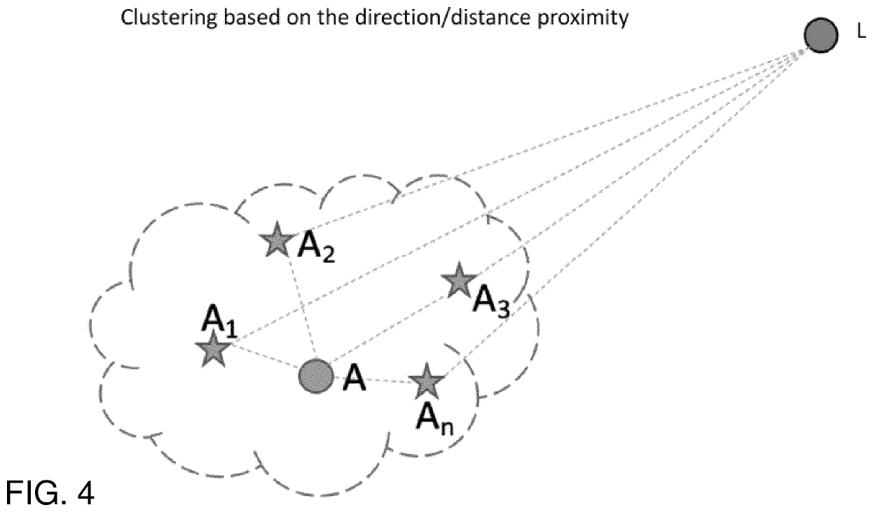

Alternatively, or additionally, the one or more parameters may include a directional proximity (close source azimuth and elevation) with respect to a listener position. The rendering control value may then be determined based on at least one of azimuth or elevation between the respective audio source position of the audio source for which the rendering control value is determined and the listener position. For example, a listener position related azimuth and elevation of N audio sources may be smaller than T_{azimuth} and Tₑₗₑᵥₐₜᵢₒₙ degrees, respectively. FIG. 4 illustrates an example of abstract visualization of clustering based on directional and/or positional/distance proximity. As can be seen in FIG. 4, it is assumed that the angle/direction difference in terms of azimuth and elevation between any two sources (e.g., A2 and An) as seen from the Listener L is smaller than T_{azimuth} and Tₑₗₑᵥₐₜᵢₒₙ degrees, respectively. These sources are then clustered together. The T_{azimuth} and Tₑₗₑᵥₐₜᵢₒₙ threshold values in degrees may be, for example, 5 degrees. It could also be assumed that since the distance between those audio sources (A, A1, A2, A3 and An) is small that they are clustered based on the positional or distance proximity.

The above described parameters may be used alone or in combination to determine the respective rendering control value for each of the plurality of audio sources. The rendering control value may then be said to be indicative of a perceptual relevance of the respective audio source. Comparing, for each of the plurality of audio sources, the rendering control value to the (predetermined) perceptibility threshold may then indicate as to whether the respective audio source is perceptually relevant, that is, whether the respective audio source fulfills a perceptual irrelevance criterion. For example, if the rendering control value is equal to or above a certain threshold value, the respective audio source may be considered to be perceptually relevant. If the rendering control value is below a certain threshold value, the respective audio source may be considered to be perceptually irrelevant, that is, the respective audio source fulfills/satisfies the perceptual irrelevance criterion. Alternative, or in addition to the above described loudness related parameters, the above-described parameters refer to perceptual localization related aspects for the estimation of a perceptual relevance/irrelevance.

In an embodiment, the modifying the audio sources may include clustering the audio sources for which the rendering control value satisfies the perceptibility threshold. The modified audio sources may then correspond to cluster audio sources. In a embodiment, the rendering the unmodified audio sources, out of the plurality of audio sources, (for which the rendering control value may not satisfy the perceptibility threshold) relative to the modified audio sources may include substituting the cluster audio sources by a smaller number of audio sources and rendering the smaller number of audio sources as the modified audio sources. For example, the N audio sources may be substituted by one or more audio sources M (M<N, preferably M=1) containing the weighted downmixed signal(s) or multichannel audio signals. That is, assuming that a total of N audio sources is being clustered, these sources may then be substituted by M audio sources. M may be the number of modified audio sources to be rendered instead of N. Hence, M audio sources still represent the same cluster.

By clustering audio sources for which the rendering control value satisfies the threshold, advantageously, several audio sources can be substituted by a smaller number of modified audio sources thus reducing the number of audio sources to be rendered.

Alternatively, or additionally, in an embodiment, the one or more parameters may include one or more of acoustic occlusion, optical occlusion, or abstraction. The rendering control value may then be determined based on a level of occlusion or abstraction of the respective audio source.

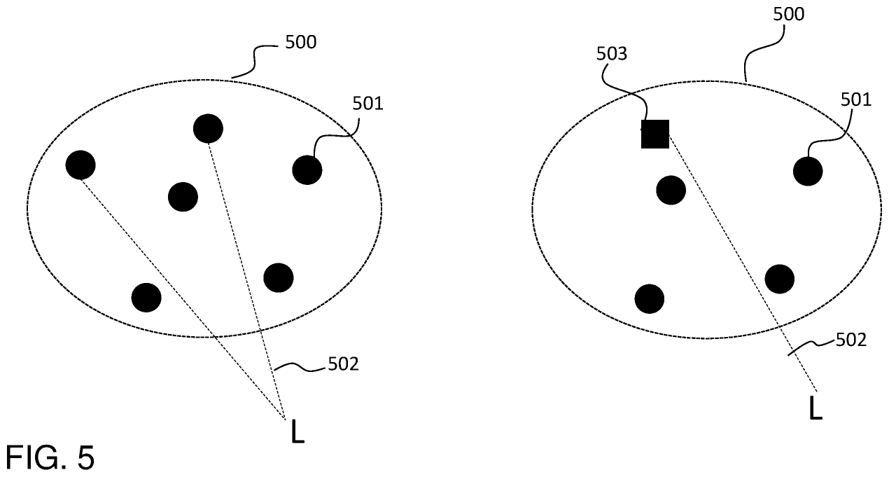

In an embodiment, the modifying the audio sources may include converting a type of the audio sources for which the rendering control value satisfies the threshold. That is, modifying the audio sources may include converting a respective audio source from one type to another. The resulting type may be rendered more computationally efficient. This is schematically illustrated in the example of FIG. 5. FIG. 5 illustrates a plurality of audio sources 501, associated to a respective audio scene 500. For example, if a distance 502 between a listener L and several audio sources 501 is sufficiently large, then those audio sources 501 (e.g., waterfall extent sound) can be substituted by one audio object 503 (e.g., distant waterfall point-source); or many audio point-sources (e.g., rain droplets) can be substituted by one Higher Order Ambisonics, HOA, (e.g., rain noise) signal.

The modified audio sources may then correspond to typecasted audio sources. The parameters to determine the respective rendering control condition (rendering control value compared to the threshold) for typecasting may, in particular, dependent on the positional and/or directional proximity and/or the level of acoustic/optical occlusion/abstraction as described above. For example, if several audio sources are occluded and still acoustically important, then those sources can simply be replaced by a single point source audio or an FOA signal.

The rendering the unmodified audio sources, out of the plurality of audio sources, (for which the rendering control value may not satisfy the perceptibility threshold) relative to the modified audio sources may then include rendering the typecasted audio sources as the modified audio sources.

In addition to the above, in an embodiment, on audio sources, out of the plurality of audio sources, which have a directivity pattern, a directivity calculation may not be performed, if the rendering control value satisfies the threshold.

An example may be a motor engine sound of a car that has a directivity. Assuming that a car is running on a circular track and a listener is standing on a particular location/stage as in a racing car scenario, the effect of a motor engine sound with directivity will be perceived when the car is passing the listener by. But when the car is at a distant location, the directivity effect is neglectable as the listener only hears a faint sound of the motor engine, making it perceptually irrelevant, and therefore it is not necessary to perform the directivity calculation. In some embodiments, the source may even be further considered to be included in the culling subset as well if there is a significant obstacle/occluder in the middle of the circular track such as a hill or a bunch of solid rocks.

In an embodiment, the directivity calculation may be skipped by additionally considering the so-called worst-case directivity gain estimate parameter. This worst-case estimate is straightforward to compute, e.g., by simply taking the maximum directivity gain within a given directivity pattern of an audio source. This estimate may be used in combination with the other existing rendering stages threshold, e.g., 60 dB culling threshold, so that if an audio source rendering gain satisfies the “Culling” stage gain threshold, the directivity calculation/stage may be skipped.

In an embodiment, the method may further include receiving control information indicative of whether to perform the modifying of some or all of the audio sources for which the rendering control value satisfies the threshold.

The following parameters may be used to control application of perceptual audio culling, clustering and typecasting rendering stages. (De-)activation parameters may be included in the control information. Such parameters may, for example, allow to disable the modifying for narrator speech signals, even if respective audio sources may have rendering control values that satisfy the threshold, i.e. fulfill the perceptual irrelevance criterion. Alternatively, or additionally, grouping data for culling/clustering/typecasting may be included in the control information. Such grouping data may, for example, include means for defining a set of audio sources within a certain area (e.g., sound emitting parts of a car) or with certain signal categories (e.g., ambiance sound of rain and wind). Alternatively, or additionally, per group, the encoder may define a culling and clustering strategy to either combine or remove objects which may be included in the control information. For example:
if all objects in a group are below a certain threshold loudness, the group may be combined into one object (loudness-based culling);
if azimuth/elevation of all objects are within a certain range, the group may be combined into one object (directional-based clustering);
if one or many objects of the group are acoustically occluded, the group may be combined into one object.

Alternatively, or additionally, a prioritization in respect to signal perceptual relevance (and its informational importance) to the listener (and listener's focus of attention) may be included in the control information. For example, culling of non-relevant audio sources may be applied (instead of their leveling/EQing) for the “cocktail party effect” reproduction to improve speech intelligibility. Alternatively, or additionally, a visibility of a graphical representation of audio source(s) to the listener (i.e., whether a visual representation of audio source is visible to the user or not) may be included in the control information. For example, an audio source may be associated with visual representation, which may be:
not in the video rendered viewport (behind the listener);
obstructed by an optically non-transparent occluder.

Such audio sources may be treated differently depending on their nature and application scenario; e.g., thresholds for positional or directional proximity conditions can differ depending on a virtual object visibility.

The following aspects may further be used to avoid frequent “toggling” of culling, clustering and typecasting rendering stages:
hysteresis (dependence of the current decision on previous decision history);
distance in respect to the listener position (and its changes over time-position velocity);
direction in respect to the listener position (and its changes over time-angular velocity), for example, time thresholds may be determined based on measured velocities.

All parameters and/or downmix matrices for the above described aspects may be defined and signaled by:
encoder—“encoder-assisted” mode (manually by content-creator) to allow content-creator to have an influence on automatic culling in the renderer (e.g., to avoid non-sensical culling);
renderer—“default” mode (automatically);
application—“system-assisted” mode (automatically) by application or system middleware.

Notably, parameters for all rendering stages can be defined per (virtual) object. All these rendering stages may be implemented as part of the MPEG-I rendering process or as the MPEG-I Audio “External Tools”. Transition from the “culling-”, “clustering-” and “typecasting-” state to the original one may be initiated (when the corresponding condition is met) and the sound source(s) energy is(are) low. That is, in a further embodiment, the above described method may be implemented by a respective two step process for determining the ‘right’ frame for applying the complexity reduction measure. This two step may include, in a first step, determining that a measure for complexity reduction (i.e. modification of audio sources as described) is to be applied, and in a second step, determining a point in time or time period for applying the respective measure.

The above described method may be implemented by a respective apparatus including one or more processors. Alternatively, or additionally the above described method may be implemented in the form of a respective program comprising instructions that, when executed by a processor, cause the processor to carry out the method. The program may be stored on a computer-readable storage medium.

While the above described aspects of controlling the rendering of a plurality of audio sources may be implemented alone or in combination within a single method, the above described aspects of complexity reduction may alternatively also be implemented by respective individual methods of processing audio as described below which may, however, also be implemented alone or in combination.

### Culling of Audio Sources

A method according to the present disclosure is directed towards the selection (i.e., “culling”) of such audio sources.

The present disclosure is directed towards a method of culling of audio sources. The culling may be performed either during the core audio decoding stage or during the audio rendering stage.

The “culling” method is directed towards removing perceptually irrelevant audio sources.

For example, when a listener starts experiencing heavy rain noise, the culling process would remove an audio source associated to a bird singing audio from the rendering pipeline.

In general, the following aspects have been considered for detecting when audio sources are not relevant:
distance (from listener to audio object)
rendering gains (of audio object)

### Problem:

However, these existing detection techniques have a variety of problems. For example, existing techniques are not capable of detecting a subclass of perceptually irrelevant audio sources. Namely, the subclass contains sources which are inaudible, but having the corresponding distance (gains) values higher/lower than a culling threshold. The threshold values may be based on the distance and gain. For example, if the source distance is bigger than a distance threshold value D, the source is culled. Alternatively, if the source gain value is lower than a gain threshold G, the source is culled. Problematically, under existing techniques, some audio sources may end up to be categorized as “unculled” but they may be perceptually irrelevant or inaudible.

### Solution:

The present disclosure is directed towards performing culling of audio sources based on additional information, such as information regarding perceptual energy/loudness-related aspects. This information allows for estimation of perceptual relevance and improvement in setting the “culling” application condition.

An aspect of the present disclosure considers relevant information during culling. The relevant information is the loudness of a single audio source. The loudness information (i.e., values) can be obtained from:
1) Metadata from existing audio standards set by the MPEG audio group, including the MPEG-H 3D audio (ISO_IEC_23008-3) or MPEG-D part 4 (Dynamic Range Control). For example the metadata may be presented for a legacy content.
2) Information for encoders set by the MPEG audio group, such as encoders compatible with MPEG-H 3D audio or MPEG-I audio standards. For example, the loudness information may be estimated and transmitted via an MPEG-H Audio Stream (MHAS) packet payload.
3) Information by an MPEG-I renderer. For example, information estimated in real time using the audio content and rendering gains.

Each of these sources may be considered individually or in combination. For example, combination of different loudness data sources (1), (2), (3) may be used for certain type of applications (e.g., for content without or with not-reliable loudness information, social VR audio content).

Another aspect of the present disclosure considers information regarding a relationship between the loudness of a single audio source and the loudness of the overall rendered audio output. Some implementations may exclude this source, e.g., in case of a SNR-based relationship. Loudness information may be signaled and treated differently depending on the different loudness definitions and measurement methods (e.g., short term, momentary, EBU R128 defined).

A further aspect of the present disclosure considers information regarding a relationship between the short term spectral energy of a single audio source and the spectral energy of the final rendered audio output associated with a psychoacoustic-masking model.

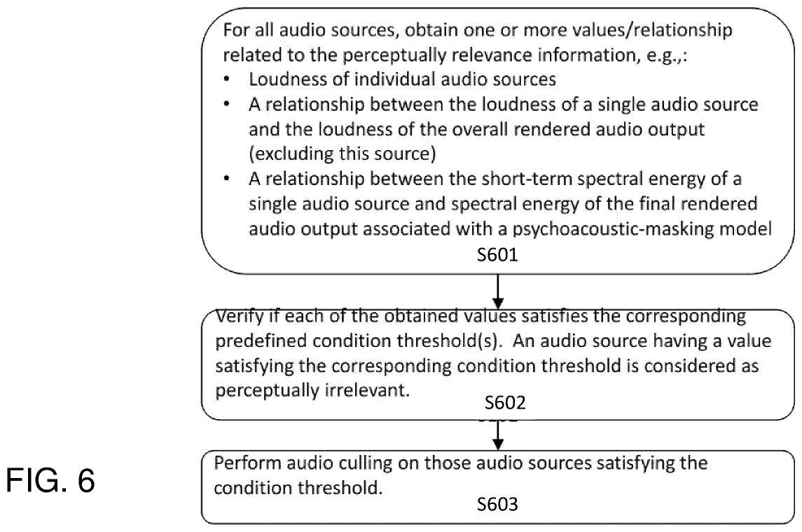

FIG. 6 illustrates an exemplary method of culling audio sources according to the present disclosure.

The method includes a first step S601. At step S601, for a plurality of audio sources, one or more values and/or relationship data related to the perceptually relevance information may be obtained. The audio sources may be received and/or predetermined. The value(s) indicate loudness of each of the audio sources. In one example, the relationship data can indicate a relationship between the loudness of a single audio source and the loudness of the overall rendered audio output (excluding the single source). The single audio source would be one of the plurality of audio sources. In another example, the relationship data would relate to a relationship between the short-term spectral energy of a single audio source and spectral energy of the final rendered audio output associated with a psychoacoustic-masking model. The single audio source would likewise be one of the plurality of audio sources.

At step S602, each of the values/data from S601 would be verified whether they satisfy the corresponding predefined condition threshold(s). An example will be an “SNR” value, where a single audio source is considered as the “useful Signal” and the rest of audio sources are considered “Noise”. The SNR value is then compared to a threshold. The threshold value may be preset or may be determined dynamically. An audio source having a value satisfying the corresponding condition threshold is considered as perceptually irrelevant. A subset of perceptually irrelevant sources is then chosen from the plurality of sources from S601.

At step S603, audio culling is performed on the perceptually irrelevant audio sources from S602 that satisfied the condition threshold. Step S603 outputs information that relates to the state of an audio source (culled or unculled). For example, the state of an audio source which can be “culled” or “unculled” can be expressed by a Boolean variable indicating “true” or “false”. For example, a boolean variable called “isCulled” is specified and initialized with “false”. After the processing it may be set to “true” by an assignment operator “isCulled=true”. This variable is then passed down the processing chain to exclude this audio source for rendering. In subsequent steps (not shown) this culling information is provided to an audio render. The audio renderer uses the culling information in conjunction with the audio sources to determine which audio sources would be rendered.

### Clustering of Audio Sources

The present disclosure is further directed towards performing clustering of audio sources. The “clustering” stage should substitute several audio sources by a smaller number of modified sources. Clustering refers to grouping based on certain conditions, (e.g., distance proximity of audio sources, such as sources that are close to each other). The clustering may be performed either during the core audio decoding stage or during the audio rendering stage.

### Problem:

Current solutions provided by the standardized audio group of MPEG do not support clustering of audio sources for the purpose of decreasing computational and memory system workload without perceptual quality degradation of the resulting rendered audio output. However, such clustering feature is an important feature that is needed to be supported in future standardized solutions of standardized MPEG audio features.

### Solution:

The present disclosure is directed to clustering of audio sources that is based on additional perceptual localization-related aspects for estimation of perceptual relevance and setting the “clustering” application condition.

A further aspect of the present disclosure is determining clustering based on positional proximity (i.e., close source locations) in respect to a listener position. For example, if the distance between N audio source locations is smaller than T_{distance}% of the distance between the listener and the closest source, then these audio sources are substituted by one or more audio sources M, where M<N, preferably M=1. The M resulting audio sources should contain weighted downmixed signal(s) or multichannel audio signals.

The T_{distance}% refers to a variable denoting a percentage value, (e.g., 5%). As a listener explores a scene containing several audio sources (i.e., the original N audio sources), the distance between the listener to a closest source can be calculated. This distance to this closest source can be referred to as a variable Tc. Additionally, the distance between each of the remaining audio sources in that scene can also be calculated. Each of these distances is compared against Tc. If a distance between two sources is less than T_{distance}% of Tc, then these sources are clustered (grouped together). The cluster may add to it more members (audio sources) since the comparison is done on all audio sources. Assuming that a total of N audio sources is being clustered, these sources are then substituted by M audio sources. Mis the number of audio sources to be rendered instead of N. Hence, M audio sources still represent the same cluster.

FIG. 3 illustrates an example of abstract visualization of clustering based on positional proximity. As can be seen in FIG. 3, cluster A 301 contains the audio sources 301A closest to one another in terms of distance. Cluster B 302 contains different sources 302B that, likewise, are closest to one another in terms of distance. Conversely, source X 303 is located further away from any audio source 301A, 302B in both clusters A 301 and B 302, and hence is not assigned to either cluster.

A further aspect of the present disclosure is determining clustering based on directional proximity (i.e., close source azimuth and elevation) in respect to a listener position. It should be noted that perceptual localization ability of the listener has finer resolution on azimuth rather than on elevation. For example, if the listener position related azimuth and elevation of N audio sources is smaller than T_{azimuth} and Tₑₗₑᵥₐₜᵢₒₙ degrees respectively, then these audio sources are substituted by one or more audio sources M (M<N, preferably M=1) containing the weighted downmixed signal(s) or multichannel audio signals. The T_{azimuth} and Tₑₗₑᵥₐₜᵢₒₙ are each threshold values in degrees, e.g., 5 degrees, for azimuth and elevation, respectively, representing the directional proximity. As a listener explores a scene containing several audio sources (i.e., the original N audio sources), the angle/direction difference between any two sources as seen from a listener pose can be calculated (based on azimuth and elevation). If the angle/direction difference between two sources is less than T_{azimuth} and Tₑₗₑᵥₐₜᵢₒₙ, then these sources are clustered (grouped together). The cluster may add to or remove from it more members (audio sources) since the comparison is done on all audio sources.

FIG. 4 illustrates an example of abstract visualization of clustering based on directional and/or positional/distance proximity. As can be seen in FIG. 4, it is assumed that the angle/direction difference in terms azimuth and elevation between any two sources (e.g., A2 and An) as seen from the Listener L is smaller than T_{azimuth} and Tₑₗₑᵥₐₜᵢₒₙ degrees, respectively. These sources are then clustered together. It could also be assumed that since the distance between those audio sources (A, A1, A2, A3 and An) are so close to each other so they are clustered based on the positional or distance proximity.

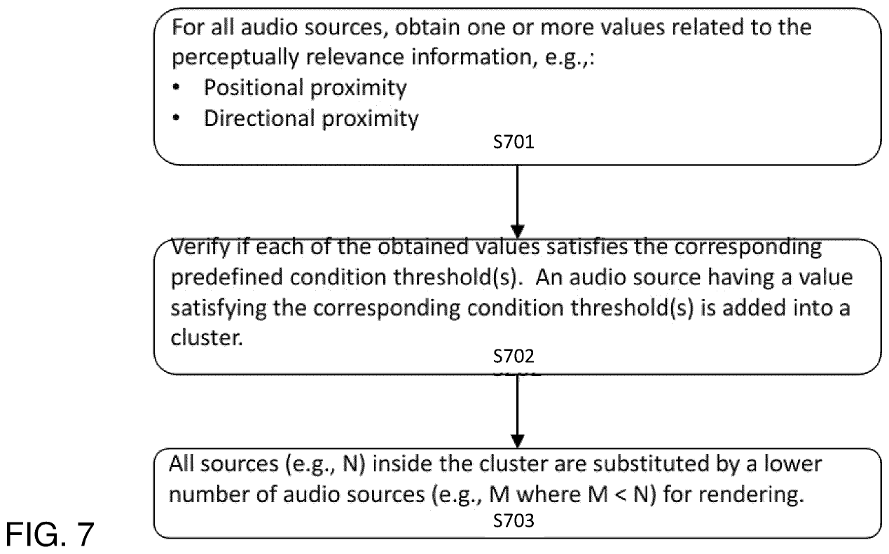

FIG. 7 illustrates an exemplary method of clustering audio sources according to the present disclosure.

The method includes a first step S701. At step S701, for a plurality of audio sources, one or more perceptual relevance information values for each of the audio sources may be determined. The perceptual relevance information may be one of i) positional proximity and/or ii) directional proximity.

At step S702, the values from S701 are each verified to determine whether they satisfy a corresponding predefined condition threshold(s). An audio source having a value satisfying the corresponding condition threshold(s) is added into a cluster.

At step S703, all sources (e.g., all audio sources of a number N) inside the cluster are substituted by a lower number of audio sources (e.g., M where M<N) for rendering. The substitution may involve a weighted downmix operation of the whole set or a subset of N audio sources. It may also be obtained by simply culling some of the sources.

The output of step S703 may be a set of M audio sources to be rendered. These M audio sources are substituting the original N audio sources without perceptual quality degradation when rendered.

### Typecasting of Audio Sources

The present disclosure is directed to “typecasting” stage which converts one or several audio source(s) from one type to another. The resulting type is expected to be rendered more computationally efficient. The “typecasting” may be performed either during the core audio decoding stage or during the audio rendering stage.

For example, the “typecasting” method would determine if the distance between a listener and each of the several audio sources is sufficiently large (e.g., by comparing the distance between the listener and the audio source to a threshold). If the distance is large enough, then those audio sources (e.g., waterfall extent sound) can be substituted by an audio object/source (e.g., distant waterfall point-source). Alternatively, those audio point-sources (e.g., rain droplets) can be substituted by one HOA (e.g., rain noise) signal.

### Problem

Current solutions provided by the standardized audio group of MPEG do not support typecasting of audio sources for the purpose of decreasing computational and memory system workload without perceptual quality degradation of the resulting rendered audio output. However, typecasting is an important feature that is needed to be supported in future standardized solutions of standardized MPEG audio features.

### Solution:

The present disclosure is directed to typecasting of audio sources that is based on one or more of these conditions:
positional and directional proximity (see clustering discussion above for more detail regarding measurement of these parameters)
level of acoustic/optical occlusion/abstraction

The level of acoustic/optical occlusion/abstraction can be measured by factoring in several aspects such as the acoustic property (e.g., transmission, absorption, reflection coefficients) of an occluder that blocks the direct view from the listener and the distance of an audio source from the listener. For example, if several audio sources (multichannel audio sources) are occluded and still acoustically important, then those sources can simply be replaced by a single point source audio or an FOA. A source is considered occluded if the source is obstructed by an occluding material which makes it not visible to the listener. An occluding material is described by its acoustical properties such as transmission, reflection and absorption coefficients. In this example, the occluded multichannel audio sources may be replaced by a mono audio source obtained from the dominant channel of the multichannel audio or from a weighted mix of the audio sources. Alternatively, the occluded multichannel audio sources may be replaced by a stereo audio source.

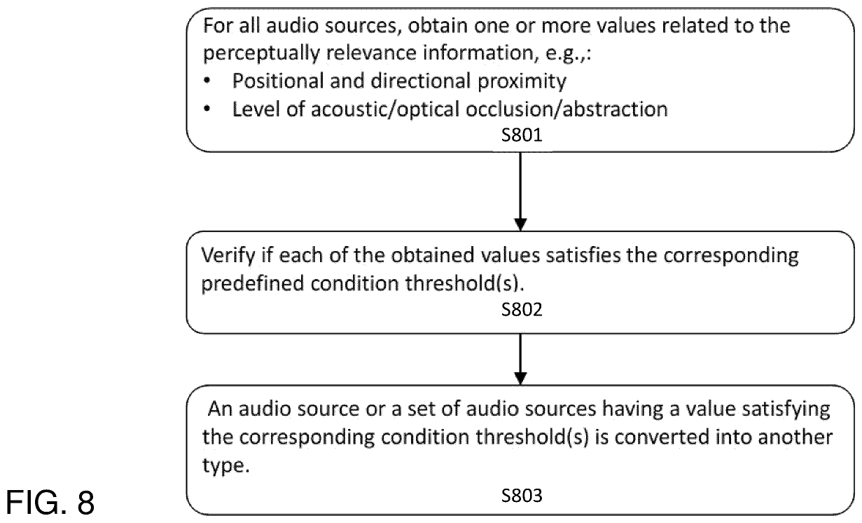

FIG. 8 illustrates an exemplary method of typecasting audio sources according to the present disclosure.

At step S801, each audio source of a plurality of audio sources may be evaluated to obtain one or more values for the respective audio source, where the value(s) indicate perceptual relevance information. For example the value(s) can indicate (i) positional proximity; (ii) directional proximity; and/or (iii) level of acoustic/optical occlusion/abstraction.

At step S802, for each audio source, each of the value(s) is evaluated to determine whether it satisfy a corresponding predefined condition threshold(s). For example, the threshold is 5 degrees. If the obtained value is lower than 5 degrees, then it is considered to be in the near proximity in terms of directional proximity criterion. The resulting sources that satisfy the threshold are categorized as typecasting sources.

One can then say that “the obtained value satisfies the condition threshold”.

At step S803, the typecasting sources from step S802 are converted into another type. An audio type may be a multichannel audio (e.g., stereo, 5.0, 7.0, 11.0), mono audio, Ambisonics (FOA, HOA)).

### Control of Culling, Clustering and Typecasting Stages

The culling, clustering and typecasting methods described below can be performed either alone or in various combinations.

Each of these methods can be implemented in the decoding and/or rendering stages of an audio decoder. The audio decoder and/or decoding method can be compatible with standards set by the audio group of MPEG of the ISO/IEC organization, such as the MPEG-I immersive audio standard. For example, each of these stages alone or in combination can be implemented as part of the MPEG-I rendering process or as external tools for the MPEG-I immersive audio standard.

Each method can be (de-)/activated by control information. The control information can be provided as conditions. The control information may be in the form of a parameter to be processed by a system and/or device. The parameter(s) can be defined per (virtual) object

The application of the inventive methods, i.e., culling, clustering and typecasting, may result in the change of audio source state. For example, an audio source state is changed from “unculled” to “culled” or the other way around. If such a change happens then the actual change in the rendering should ideally be done when the corresponding audio source loudness is low. This is to avoid an abrupt change of a loud signal. In this case, the control information could be the loudness or energy threshold which sets a threshold of when such a change is triggered. Additionally, the control information could include the maximum allowed changes within a certain period to avoid, for example, highly repetitive changes within a short period. One example, only one change is allowed within 1 minute for speech signal. Alternatively, the control information may be set by a listener or an application at the decoder/renderer side.

Examples of control information parameters that can be used to control application of perceptual audio culling, clustering and typecasting rendering stages include activation or deactivation parameters. For example, such parameters can indicate when certain audio source(s) is disabled (e.g., signaling to disable a narrator speech signal). An activation example may be applied to certain audio sources in a scene such as car audio sources. Normally, a car sound may be active (e.g., engine started, car moving) or inactive (e.g., engine off, car parked) in a scene. In this case, the activation implies that the inventive methods (i.e., culling, clustering, typecasting) may be applied to car audio sources. This is not applicable for the narrator speech signal for example, where it is expected to always render the speech signal, hence the deactivation control.

Another example of control information parameters is grouping data. For example, the grouping data can be a set of audio source IDs that belong together such as parts of a car that emit sound (tyres, engine, horn). These audio sources can be grouped together if the directional differences between those sources relative to a listener position is less than 5 degrees (directional proximity). The grouping data can be used for controlling each of the culling/clustering/typecasting. For example, the grouping data can provide means for definition of a set of audio sources within a certain area (e.g., sound emitting parts of a car) or with certain signal categories (e.g., ambiance sound of rain and wind).

When grouping data is available, an encoder, decoder, and/or renderer can define a culling and clustering strategy to either combine or remove audio sources (e.g., objects). For example, if all audio sources in the group are below a certain threshold loudness, the group is combined into one object (loudness-based culling). Alternatively, if azimuth/elevation of all objects of a group are each within a certain respective range, the group can be combined into one object (directional-based clustering). Alternatively, if one or many objects/sources of the group are acoustically occluded, the group is combined into one object/source.

Another example of control information parameters is related to prioritization. For example, the control information can provide for prioritization in respect to signal perceptual relevance (and its informational importance) to the listener (and listener's focus of attention). For example, the prioritization parameters can control when the culling of non-relevant audio sources is applied (instead of their leveling/EQing) for a “cocktail party effect” reproduction to improve speech intelligibility.

Another example of control information parameters is visibility of graphical representation of audio sources to the listener (i.e., whether a visual representation of audio source is visible to the user or not). For example an audio source can be associated with visual representation, which is (i) not in the video rendered viewport (behind the listener) and (ii) obstructed by an optically non-transparent occluder. Such audio source can be treated differently depending on their nature and application scenario; e.g., thresholds for positional or directional proximity conditions can differ depending on a virtual object visibility. The control information parameters would define one or more sets of predefined condition thresholds for object visibility. The following aspects can be used to avoid frequent “toggling” of culling, clustering and typecasting rendering stages:
hysteresis (dependence of the current decision on previous decision history)
distance in respect to the listener position (and its changes over time-position velocity)
direction in respect to the listener position (and its changes over time-angular velocity)

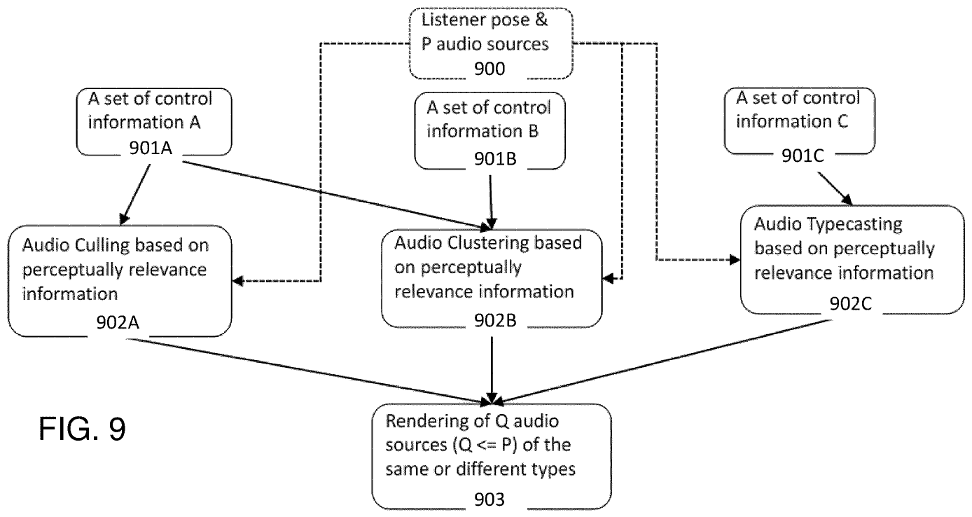

FIG. 9 illustrates exemplary uses of control information to control one or more the inventive culling, clustering and/or typecasting methods. For example, at 900 listener pose (i.e., location) information and a plurality of audio sources P may be received. At 901A control information A can be received. At 901B control information B can be received. At 901C control information C can be received. In various embodiments, 901A, 901B, and 901C can each be performed individually, or in combination. Control information A illustrates an example of when the information controls both culling and clustering methods. Control information B and C are used to control only the clustering and typecasting methods, respectively.

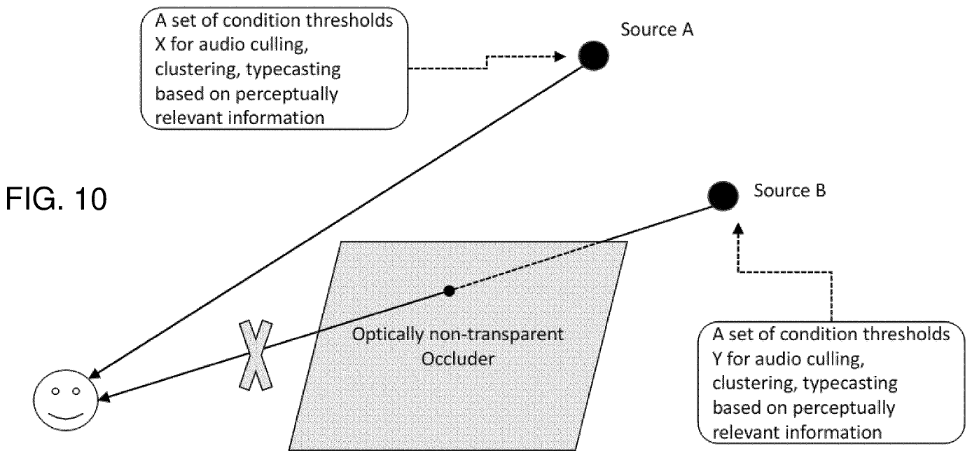

FIG. 10 illustrates the control information parameters that would define one or more sets of predefined condition thresholds for object/source visibility. On one hand, source A is clearly visible from the listener location (not obstructed by an occluder) and therefore a set of condition thresholds X is applied to perform the inventive audio culling, clustering, typecasting. On the other hand, source B is obstructed by an occluder and therefore another set of condition thresholds Y is applied to perform the inventive audio culling, clustering, typecasting. The control information here is whether a visual representation of audio source is visible to the user or not.

### Apparatus for Implementing Methods According to the Disclosure

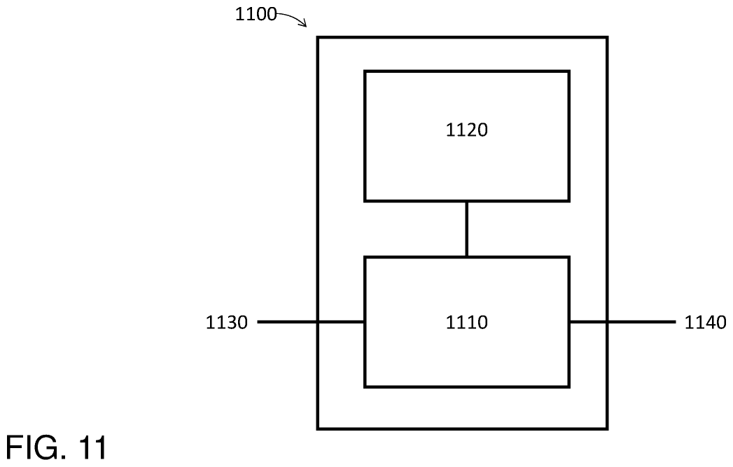

Finally, the present disclosure likewise relates to an apparatus (e.g., computer-implemented apparatus) for performing methods and techniques described throughout the present disclosure. FIG. 11 shows an example of such apparatus 1100. In particular, apparatus 1100 comprises a processor 1110 and a memory 1120 coupled to the processor 1110. The memory 1120 may store instructions for the processor 1110. The processor 1110 may also receive, among others, suitable input data 1130, depending on use cases and/or implementations. The processor 1110 may be adapted to carry out the methods/techniques described throughout the present disclosure and to generate corresponding output data 1140 depending on use cases and/or implementations.

### Interpretation

A computing device implementing the techniques described above can have the following example architecture. Other architectures are possible, including architectures with more or fewer components. In some implementations, the example architecture includes one or more processors (e.g., dual-core Intel® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics.

Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art.

Therefore, the scope of the appended claims should be accorded the broadest interpretation so as to encompass all such modifications and similar arrangements.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present disclosure discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present disclosure, various features of the present disclosure are sometimes grouped together in a single example embodiment, Fig., or description thereof for the purpose of streamlining the present disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some, but not other features included in other example embodiments, combinations of features of different example embodiments are meant to be within the scope of the present disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the present disclosure may be practiced without these specific details. In other instances, well-known methods, structures and techniques have not been shown in detail in order not to obscure an understanding of this description.

Thus, while there has been described what are believed to be the best modes of the present disclosure, those skilled in the art will recognize that other and further modifications may be made thereto without departing from the spirit of the present disclosure, and it is intended to claim all such changes and modifications as fall within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

### ENUMERATED EXAMPLE EMBODIMENTS

Various aspects and implementations of the present disclosure may also be appreciated from the following enumerated example embodiments (EEEs), which are not claims.

EEE1. A method for processing a plurality of audio sources, the method comprising: determining, for each of the plurality of audio sources, a respective culling value; comparing, for each of the plurality of audio sources, the respective culling value of each of the plurality of sources to a threshold to determine whether this is a culling source;
outputting information identifying a culling subset of the plurality of audio sources, wherein the culling subset includes the culling source(s) identified by the comparison.

EEE2. The method of EEE1, wherein the culling value is based on at least one of: a loudness value, a relationship between loudness of a single source and overall loudness of overall rendered audio, and a relationship between short-term spectral energy of a single audio source an overall spectral energy of final rendered audio.

EEE3. The method of EEE1, further comprising rendering the plurality of audio sources, wherein the rendering only renders audio sources that are not part of the culling subset of the plurality of audio sources.

EEE4. A method for processing a plurality of audio sources, the method comprising: determining, for each of the plurality of audio sources, a respective clustering value; comparing, for each of the plurality of audio sources, the respective clustering value of each of the plurality of sources to a threshold to determine whether this is a cluster source;
outputting information identifying a cluster subset of the plurality of audio sources based on the comparison.

EEE5. The method of EEE4, wherein the clustering value indicates positional proximity.

EEE6. The method of EEE5, wherein the threshold value is a fraction of a distance between a listener and a closest source.

EEE7. The method of EEE6, wherein the comparison compares a distance between an audio source and the listener to the threshold value.

EEE8. The method of EEE4, wherein the clustering value indicates directional proximity.

EEE9. The method of EEE8, where in the threshold value is at least one of azimuth angle or elevation between sources with respect to a listener position.

EEE10. The method of EEE4, further comprising a set of clusters, and rendering the set of clusters by an audio renderer.

EEE11. A method for processing a plurality of audio sources, the method comprising: determining, for each of the plurality of audio sources, a respective typecasting value; comparing, for each of the plurality of audio sources, the respective typecasting value of each of the plurality of sources to a threshold to determine whether this is a typecasting source;
outputting information identifying a new type of source replacing the original source type.

EEE12. A method of processing control information, wherein the control information determines whether to perform one or more of methods of EEEs 1, 4 and/or 11.

EEE13. The method of EEE12, wherein the control information is one of: activation or deactivation parameters, grouping data, prioritization information, and/or visibility information.

EEE14. The method of any of EEEs 1-13, wherein the method is performed in accordance to a standard set by the MPEG audio group of ISO/IEC.

EEE15. The method of EEE14, wherein the standard is the MPEG-I Immersive Audio standard.

1-23. (canceled)

24. A method of rendering audio sources, the method comprising:
determining, for each of a plurality of audio sources, a rendering control value based on one or more parameters indicative of a perceptual relevance of the respective audio source, wherein the one or more parameters include a loudness of a respective audio source, and a relationship between the loudness of the respective audio source and a loudness value related to audio output resulting from rendering the plurality of audio sources, wherein the loudness value is obtained from loudness information transmitted via an audio stream or from an external data source, and from information estimated using audio content and rendering gains;
comparing, for each of the plurality of audio sources, the rendering control value to a perceptibility threshold to determine whether a respective audio source fulfills a perceptual irrelevance criterion;
modifying audio sources, out of the plurality of audio sources, for which the rendering control value satisfies the threshold to obtain modified audio sources; and
rendering unmodified audio sources, out of the plurality of audio sources, relative to the modified audio sources.

25. The method of claim 24, wherein the one or more parameters include a relationship between the loudness of a single audio source and the loudness of audio output resulting from rendering the plurality of audio sources excluding said single audio source.

26. The method of claim 24, wherein the one or more parameters include a relationship between a short-term spectral energy of a single audio source and a spectral energy of audio output resulting from rendering the plurality of audio sources.

27. The method of claim 24, wherein the rendering determines rendered audio output that is associated with a psychoacoustic-masking model.

28. The method of claim 24, wherein the modifying the audio sources for which the rendering control value satisfies the threshold includes culling the audio sources; and
wherein the modified audio sources correspond to a culling sub-set of the plurality of audio sources.

29. The method of claim 28, wherein the rendering the unmodified audio sources, out of the plurality of audio sources, relative to the modified audio sources includes not to render the audio sources included in the culling sub-set.

30. The method of claim 24, wherein the one or more parameters include a positional proximity of an audio source in respect to a listener position.

31. The method of claim 30, wherein the rendering control value is determined based on a distance of a respective audio source position of the audio source for which the rendering control value is determined to another audio source, and wherein the rendering control value is compared with a fraction of a distance between the listener position and a closest source position.

32. The method of claim 24, wherein the one or more parameters include a directional proximity with respect to a listener position (L).

33. The method of claim 32, wherein the rendering control value is determined based on at least one of azimuth or elevation between the respective audio source position of the audio source for which the rendering control value is determined and the listener position (L).

34. The method of claim 30, wherein the modifying the audio sources includes clustering the audio sources for which the rendering control value satisfies the threshold; and
wherein the modified audio sources correspond to cluster audio sources.

35. The method of claim 34, wherein the rendering the unmodified audio sources, out of the plurality of audio sources, relative to the modified audio sources includes substituting the cluster audio sources by a smaller number of audio sources and rendering the smaller number of audio sources as the modified audio sources.

36. The method of claim 24, wherein the one or more parameters include one or more of acoustic occlusion, optical occlusion, or abstraction; and
wherein the rendering control value is determined based on a level of occlusion or abstraction of the respective audio source, wherein the level of occlusion or abstraction of the respective audio source is measured by factoring an acoustic property of an occlude that blocks a direct view from a listener (L) and a distance of that audio source from the listener (L).

37. The method of claim 30, wherein the modifying the audio sources includes converting a type of the audio sources for which the rendering control value satisfies the threshold; and
wherein the modified audio sources correspond to typecasted audio sources.

38. The method of claim 37, wherein the rendering the unmodified audio sources, out of the plurality of audio sources, relative to the modified audio sources includes rendering the typecasted audio sources as the modified audio sources.

39. The method of claim 30, wherein on audio sources, out of the plurality of audio sources, which have a directivity pattern, a directivity calculation is not performed, if the rendering control value satisfies the threshold.

40. The method of claim 24, wherein the method further includes receiving control information indicative of whether to perform the modifying of some or all of the audio sources for which the rendering control value satisfies the threshold.

41. The method of claim 40, wherein the control information (A, B, C) is one of: activation or deactivation parameters indicating when certain audio source is disabled, grouping data for defining a set of audio sources within a certain area, prioritization information in respect to signal perceptual relevance to a listener (L), and/or visibility information indicating whether a visual representation of an audio source is visible to a user or not.

42. An apparatus comprising a processor and a memory coupled to the processor, and storing instructions for the processor, wherein the processor is adapted to carry out the method according to claim 24.

43. A non-transitory computer readable medium comprising instructions that, when executed by one or more processor(s), cause the processor(s) to carry out the method according to claim 24.
